(19) United States
(12) Patent Application Publication
(10) Pub. No.: US 2007/0055867 A1
(43) Pub. Date: Mar. 8, 2007

(54) SYSTEM AND METHOD FOR SECURE PROVISIONING OF ENCRYPTION KEYS

(76) Inventors: RAJESH KANUNGO, SUNNYVALE, CA (US); HEMANT THAKKAR, CUPERTINO, CA (US); LEWIS MCCARTHY, SUNNYVALE, CA (US); BENJAMIN LOOMIS, SARATOGA, CA (US)

Correspondence Address: DYKAS, SHAVER & NIPPER, LLP, P.O. BOX 877, BOISE, ID, 83701-0877, US

(21) Appl. No.: 11/552,574

(22) Filed: Oct. 25, 2006

Related U.S. Application Data
(63) Continuation-in-part of application No. 10/389,488, filed on Mar. 14, 2003.
(60) Provisional application No. 60/729,890, filed on Oct. 25, 2005.
(60) Provisional application No. 60/734,463, filed on Nov. 8, 2005.

(51) Int. Cl. H04L 9/00

(52) U.S. Cl. 713/156

(57) ABSTRACT

A system for secure communications. Embodiments include systems and methods for registering a recipient providing an encryption key corresponding to a recipient to a sender before the recipient has received the corresponding decryption key. Other embodiments include authenticating the identity of a recipient and assigning trust levels according to the level of authentication. Other embodiments include federating the provisioning of keys across more than one server.

### CROSS-REFERENCE TO RELATED APPLICATIONS

This application is a continuation-in-part application of application Ser. No. 10/389,488, filed Mar. 14, 2003, entitled “Systems and method for the transparent management of document rights,” which is pending and incorporated herein by this reference in its entirety.

This application also claims priority to U.S. Provisional Patent Application No. 60/729,890 filed Oct. 25, 2005, U.S. Provisional Patent Application No. 60/734,463, filed Nov. 8, 2005, all of which are hereby incorporated by reference in their entirety.

### FIELD OF THE INVENTION

The invention relates to generally to a system and method for encryption communications, and more particularly to a secure system and method for providing public and private encryption keys to senders and recipients of messages.

### BACKGROUND OF THE INVENTION

A public key infrastructure (PKI) is a system that allows users to send private or authenticated messages to each other and allows trusted third-party authentication of user identities. Privacy is ensured by encrypting messages using public-key cryptography, which generally allows users to communicate securely using an insecure channel without requiring that the users have access to a shared, secret cryptographic key. Authentication is necessary to allow a recipient to insure that a message was in fact sent by the sender identified in the message and not sent or modified by a malicious third party.

The use of a shared, secret key is called symmetric encryption. In symmetric encryption, the encryption method is analogous to a lock, and the key is used to both encrypt (lock) and decrypt (unlock) the message.

Public key cryptography is performed using a pair of keys, designated the private key and the public key. The private key is generally kept secret, while the public key may be widely distributed. Using the lock analogy, one key locks the lock while the other is required to unlock it. It should not be possible to deduce the private key of a pair given the public key.

Several methods of generating public/private key pairs have been proposed. One of the most popular was invented by Rivest, Shamir, and Adleman, and their algorithm is referred to as the RSA algorithm, or just RSA. Another is the ElGamal algorithm invented by Tahal ElGamal and used in the OpenPGP standard, an open standard followed by the free GNU Privacy Guard software and some versions of the Pretty Good Privacy (PGP) software, among others.

In a PKI, public keys are distributed through the use of an identity certificate, which binds a user's public key with the user's identity. The identity may include the users name, e-mail address, physical address, and so on. The integrity of the certificate is insured by the use of the digital signature of the issuing certificate authority (CA). CAs may be public or private, and include commercial CAs that charge for their services; institutions, such as universities, governments; and businesses that issue certificates to their employees.

A digital signature allows a recipient of a message to be confident of the identity of the sender, and both the recipient and sender to be confident that the message is not modified during transmission. To sign a message, the sender encrypts the message using the sender's private key. The recipient may decrypt the message using the sender's public key. Because the public key will only decrypt a message encrypted with the corresponding private key, the recipient may be confident that the owner of the public and private key pair actually sent the message. To sign a certificate, the sender signs the message with its private key, and the recipient of a certificate may verify the certificate by decrypting the message with the sender publicly communicated public key. Alternatively, to computation, the sender may generate a digest or hash of the original message, then encrypt the digest with its private. The overall message will then contain the original message, the cleartext digest, and the encrypted digest.

Encryption may be combined with digital signatures. For example, to ensure that only a recipient may read a message, the sender may encrypt the message using the recipient's public key. The sender may then sign the message using the sender's private key.

Certificate provisioning (provisioning) is the process of generating a public/private key pair for a sender, verifying the sender's identity, providing the keys to the sender, and transmitting an authenticated, signed certificate containing the sender's public key to recipients.

To improve security, senders may use two separate certificates, one for encryption, and one for signing. In these systems, a PKI must supply two certificates to a user, and a sender may send two certificates to a recipient.

Authentication is the process by which a PKI or a user confirms the identity of another user; in other words, it is a way to insure that users are who they say they are. Authentication should be distinguished from authorization, the process wherein resources may be used only by those authenticated users that have been granted authority to use them.

Public key cryptography is subject to a series of standards. PKCS refers to public key cryptography standards published by RSA Data Security, Inc. While the PKCS standards are proprietary, many have been adopted by standards organizations.

PKCS#10 standardizes the format of messages sent to a CA to request certification of a key pair (a certificate signing request) and corresponds to RFC 2986. PKCS#12 defines a file format commonly used to store and exchange private keys with their accompanying public key certificates.

The processes described above are described in more detail in “Applied Cryptography,” by Bruce Schneier.

Other standards used in communications systems include Hypertext Transfer Protocol, HTTP, a protocol used to transfer information between clients and servers on the World Wide Web, and HTTPS, a URI scheme that adds an encryption layer to HTTP. HTTP 1.1 is defined in RFC 2616. Secure Sockets Layer, SSL, and its successor, Transport Layer Security, TLS, are secure cryptographic protocols for transferring information via the Internet and are defined in RFC 2246 and its successors.

In a typical PKI, certificate provisioning involves several manual steps: 1) the user requests a certificate, often to an company information technology (IT) specialist, 2) the specialist arranges for a certificate with a CA, supplying documentation that authenticates the identity of the user, 3) the CA issues the private key and a certificate containing a public key to the specialist, 4) the specialist installs the certificate on the user's computer equipment, 5) the specialist configures software, such as e-mail software, to use the certificate. After certificate provisioning is complete, secure messages may be sent by the user.

There are systems that automate one or more steps in this process, including the use of a certificate signing request (CSR), but these processes are ultimately cumbersome and generally require the intervention of a specialist.

In a typical PKI, a sender must acquire the recipient's public key or certificate before composing a message to the recipient. Often, the sender will send a digitally signed request to a recipient, who then responds with his own digitally signed reply. This exchange of digital signatures provides each user with the certificate of the other, so that secure messages may be exchanged.

It is apparent that the provisioning process for a typical PKI is cumbersome, time consuming, and prone to error. Furthermore, users must carry on meta-communication to exchange keys prior to initiating secure communications.

While the examples above involve e-mail communications, other applications also require encrypted communications and the use of a PKI, including secure communication of documents, transmission of financial data, purchase transactions, and the like. Many of these applications are automatic, making it difficult for the provisioning of certificates and the exchange of certificates prior to initiating the first secure communication between the parties involved.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a message sequence chart showing an embodiment of certificate provisioning to sender client.

FIG. 2 is a block diagram of an embodiment of an e-mail communication.

FIG. 3 is a message sequence chart showing an embodiment of an exemplary embodiment of certificate provisioning to a recipient client.

FIG. 4 is a block diagram of an embodiment of a computer.

FIG. 5 is a message sequence chart showing an embodiment of message authentication.

FIG. 6 is a message sequence chart showing an embodiment of payment authentication.

FIG. 7 is a message sequence chart showing an embodiment of foreign certificate authentication.

FIG. 8 is a message sequence chart showing federation of certificate provisioning.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

Using traditional methods, certificate provisioning can be a cumbersome process involving communication over often insecure channels in parallel to the desired secure channel. Traditional methods often limit participants to secure communication between members of a particular organization. Embodiments described below may free the participants from the necessity of negotiating an exchange of keys before exchanging secure communications, allow communication between recipients having certificates or keys issued by multiple certificate authorities, and allow authentication without resorting to communications via external channels.

In the following description and in the figures, like elements are identified with like reference numerals. The use of “or” indicates a non-exclusive alternative without limitation unless otherwise noted. Where appropriate, certificate requests correspond to the PKCS#10 standard, and exchange and storage formats for certificates and private keys conform to the PKCS#12 standard. These standards are incorporated herein by this reference.

In the following description, a client is a software application or set of applications that runs on a computer that interacts with a server to perform some operation. A server is a computer or device that manages a data resource. A client may, without limitation, communicate with a server over a network. A sender generally refers to a person who sends a message and a recipient generally refers to a person who receives a message. Thus, a recipient client refers to a software application used by a person to interact with a server, and to receive messages from a sender. However, depending on context, it is common to refer to a recipient as either the person receiving the message or the software application that the person uses to receive the message (i.e. the recipient client.) A sender client refers to a software application used by a person to interact with a server and to send messages from a recipient. Depending on context, a sender may refer to a person or a sender client.

Basic Authentication

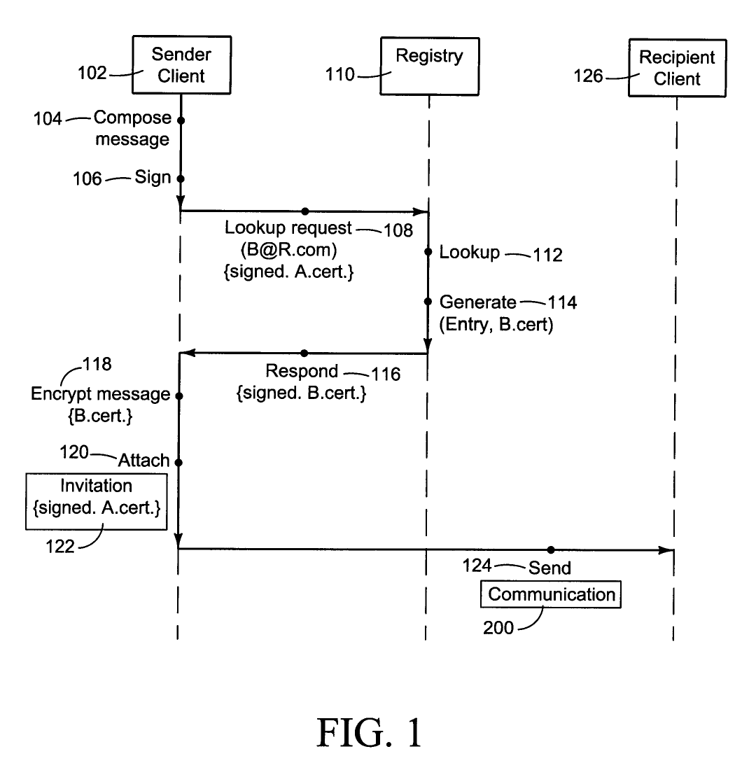

FIG. 1 is a message sequence chart illustrating the sending of a secure communication to a recipient that does not have a certificate. A message sequence chart is a graphical and textual description of the interaction between system components; thus, it contains a representation of both the components comprising a system as well as the method of interaction between the components.

In FIG. 1, a sender may compose 104 a message on sender client 102. For illustration, the sender will be referred to as “A,” and the recipient as “B.” The message composed in step 104 may be, without limitation, an e-mail message. Message formats may include, without limitation, ASCII text, MIME (currently defined in RFC 2822), and S/MIME (defined in RFC 3211, 3212, 2632, and 2633). Sender client 102 may include a software application supporting the sender client functions described in FIG. 1 running on a computer. Software applications include, without limitation, a commercially available e-mail program such as Microsoft Outlook® with a plug-in software component containing the sender client functions installed, a stand-alone e-mail program with the sender client functions built in, a web-browser application, a purchase transaction application, or any other software application capable of generating a message and supporting the sender client functions. The computer running the software application may include, without limitation, a personal computer, a workstation, a personal digital assistant (PDA), a web-enabled cell-phone, or any electronic computing device capable of running the software application.

After the message is composed in step 104, sender client 102 optionally signs 106 a request containing the address of the recipient, for example, “B@R.com.” The request is preferably signed with the private key of the sender. In some embodiments, the request may be signed using the certificate of the sender. The sender client then sends a lookup request 108 to registry 110. In lookup step 112, registry 110 searches for an entry corresponding to the address of the recipient, B@R.com. If a corresponding entry is not found, registry 110 generates 114 a public/private key pair and corresponding certificate, B.cert, and registers B@R.com in the registry. The registration information includes at least an identifier, such as the e-mail address, and the public/private key pair. Additional information may be stored at the time of registration or added later. Such additional information may include, without limitation, a unique identifier other than an e-mail address, the registrant's certificate, name, physical address, and phone number. Registry 110 then responds 116 to sender client 102. The response is signed with the certificate corresponding to the recipient, B.cert.

Upon receiving the signed response, sender client 102 encrypts the message composed in step 104 with the public key in the certificate provided by the signed response. Sender client 102 may also store the certificate for future communications with the recipient. Sender client 102 may attach 120 an invitation 122 to the encrypted message and optionally sign the resulting communication 200; that is, the message plus the invitation 122. Sender client 102 then sends 124 communication 200 to recipient client 126. In an alternative embodiment, registry 110 may send a communication containing an invitation to recipient client 126.

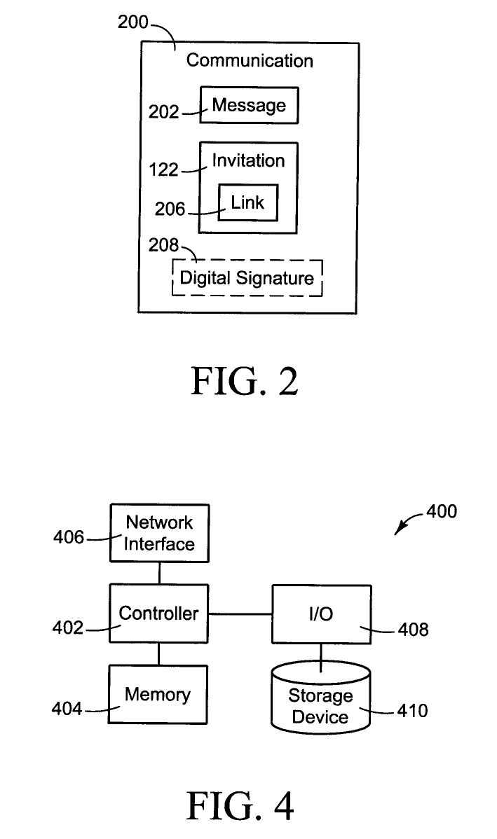

FIG. 2 illustrates an embodiment of an e-mail communication 200 to the recipient. Communication 200 may include a message 202 composed in step 104, and an invitation 122. Message 202 may be encrypted using the recipient's public key. Communication 200 may be digitally signed, and contain a digital signature 208 that includes the certificate of the sender, A.cert. Invitation 122 may include a link 206, which may include a uniform resource locator (URL) referring to a certificate server, or may include an executable program, either compiled program or a script.

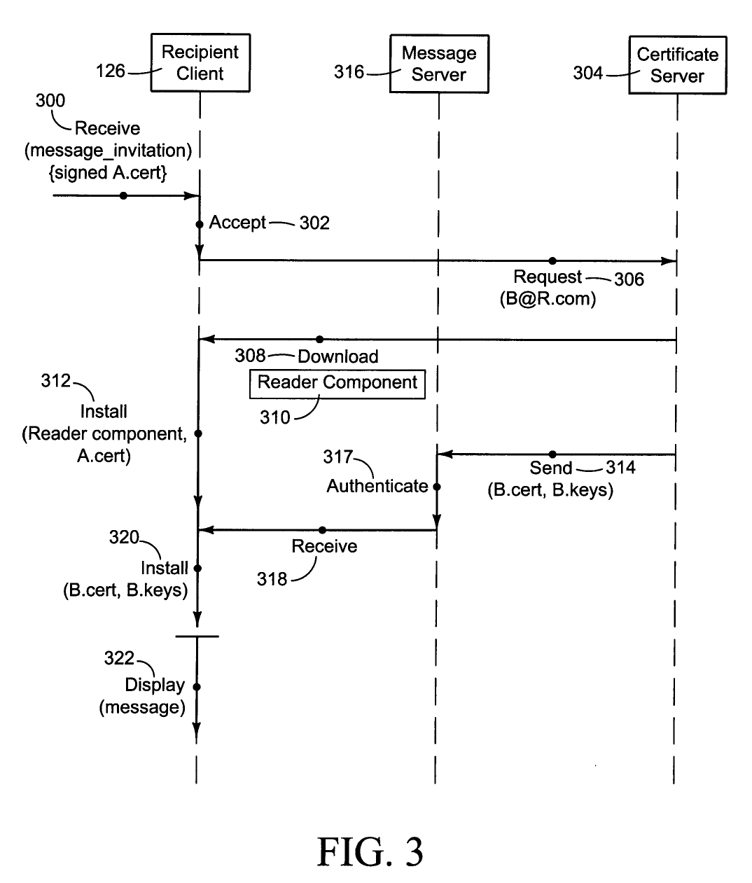

FIG. 3 is a message sequence chart illustrating an exemplary embodiment of providing a certificate to a recipient client. The sequence in FIG. 3 assumes that the recipient client does not already have the capability to read the sender's message. Upon receiving 300 a message plus invitation from sender client 102 (FIG. 1) at recipient client 126, a user may accept or reject the invitation. To reject, the user simply deletes the message and invitation. To accept 302, the user may select or click a link 206 included in invitation 122. Clicking link 206 sends a request 306 to certificate server 304. The request contains an identifier of the recipient, such as the recipient's e-mail address, B@R.com. Alternatively, the request may contain a unique identifier generated in response to the sender's lookup request 108 (FIG. 1) and communicated in the invitation.

In some embodiments, the invitation may include two certificates, one for encryption, and one for signing. The recipient may optionally install both sender certificates.

Certificate server 304 performs two operations in response to the receiving request 306. First, it downloads 308 a reader component 310 to recipient client 126. Upon receiving reader component 310, recipient client 126 installs 312 reader component 310. After component installation, recipient client 124 may optionally install the sender's certificate, A.cert.

Reader component 310 is a software application component that is capable of receiving a public/private key pair from certificate server 304 and encrypting or decrypting messages. Reader component 310 is preferably designed to be self-installing. As an illustrative example, recipient client 126 may be a software e-mail application such as Microsoft Outlook® or Lotus Notes®. Reader component 310 may be a plug-in, a software component that adds a set of specific features to a main software application, in this example, the encryption and certificate request features described in FIGS. 1 and 2. Typically, the main application provides a way for the plug-in to automatically install and register with the main program, along with a protocol for exchanging data with the plug-in. In some instances, plug-ins may be installed using a web-browser or by executing a program downloaded from a web resource or attached to an e-mail.

Second, certificate server 304 sends 314 a message containing the recipient's public/private key pair to the recipient client 126. The message may optionally contain the recipient's certificate, B.cert. The message may be sent through a message server 316. Recipient client 126 receives 318 the message, then installs 320 the recipient's public/private key pair, B.keys, and the certificate, B.cert. After reader component 310 and the recipient's keys are installed, the receiver may display 322 and read message 202 and any pending, unread messages sent the by the sender. For example, the sender may send multiple messages and invitations to the recipient; the recipient need accept one invitation to read all of the messages.

Using the steps shown in FIGS. 1 and 3, a sender may encrypt a message for transmission to a recipient before the recipient is registered in the PKI. Authentication is based on the message address of the recipient: by receiving and successfully processing the messages received by the sender and by the certificate server, the recipient self-authenticates

Registry 110 may include a software application capable of executing the steps shown in FIG. 1 running on computer equipment, such as a network server. Similarly, certificate server 304 may include a software application capable of executing the steps shown in FIG. 2 running on computer equipment. Additional software applications and services may be running on the computer equipment with registry 110 or certificate server 304, including, without limitation, e-mail server software and web server software. Registry 110 and certificate server 304 may also run on the same computer equipment, so that the computer equipment may serve lookup requests, generate certificates, and provide reader components to both sender clients and recipient clients.

Message server 316 may include a software application serving message requests running on computer equipment. Message server 316 may be co-resident with registry 110 or certificate server 304. Unlike some prior message encryption systems, message server 316 is not required to have the capability to encrypt or decrypt message, generate keys, or maintain a registry of users. In some instances, security may be improved by insuring that message server 316 is not co-resident with registry 110 or certificate server 304, so that a malicious third party does not have access to private decryption keys and encrypted messages residing on a single server. Furthermore, certificate server 304 may erase its copy of the user's private key, so that is not discoverable by a malicious third party.

FIG. 4 is a block diagram depicting an embodiment of computer equipment 400 suitable for hosting sender client 102, registry 110, recipient client 126, certificate server 304, or message server 316. Embodiments of computer equipment 400 may include a controller 402, a memory 404, a network interface 406, input/output (IO) circuitry 408, and storage device 110. Computer equipment 400 is not limited to embodiments having any or all of these components.

Controller 402 may comprise, for example, one or more microprocessors, digital signal processors, micro controllers, or the like. Memory 404 may be used to store messages transmitted or received by computer equipment 400. Memory 404 may also optionally be used to store instructions that are executed by Controller 402 during the operation of computer equipment 400 and may be used to store user data. Memory 404 may be provided by one or more different types of memory, including, without limitation, dynamic random-access memory (RAM), read-only memory (ROM), and flash memory.

Computer equipment 400 may use network interface 406 to transmit and receive messages to and from a wired or wireless communication network. Embodiments of interface 406 may include without limitation, 10 base two, 10 base T, 100 base T, Ethernet, universal serial bus (USB), or token-ring connections. Network interface 406 may also transmit and receive messages to and from a wireless communications network with a radio frequency signal. Embodiments of network interface 406 may include, without limitation, an antenna, or a wireless transceiver.

Computer equipment 400 may use open or proprietary communications protocols to transmit or receive messages, including, without limitation: TCP/IP, IPX/SPX, DECnet, or System Network Architecture (SNA).

Input/output circuitry 408 is electronic circuitry used to allow controller 402 to communicate with other electronic devices, including, without limitation, one or more storage devices 410. Storage device 410 may include, without limitation, an electronic hard disk, an electronic tape drive, a writable CD-ROM, or any other volatile or non-volatile storage medium.

Message-Only Authentication

The authentication process can result in varying levels of trust, depending on the quality of the identity verification step. The first time a user becomes known to a the PKI shown in FIGS. 1 and 3, the user's trust level is “unverified,” because the recipient's certificate is created in response to a lookup request. Trust is gained when the recipient receives and processes the message received in step 318. Trust is raised further, to “message verified” or “e-mail verified,” when an exchange of messages occurs.

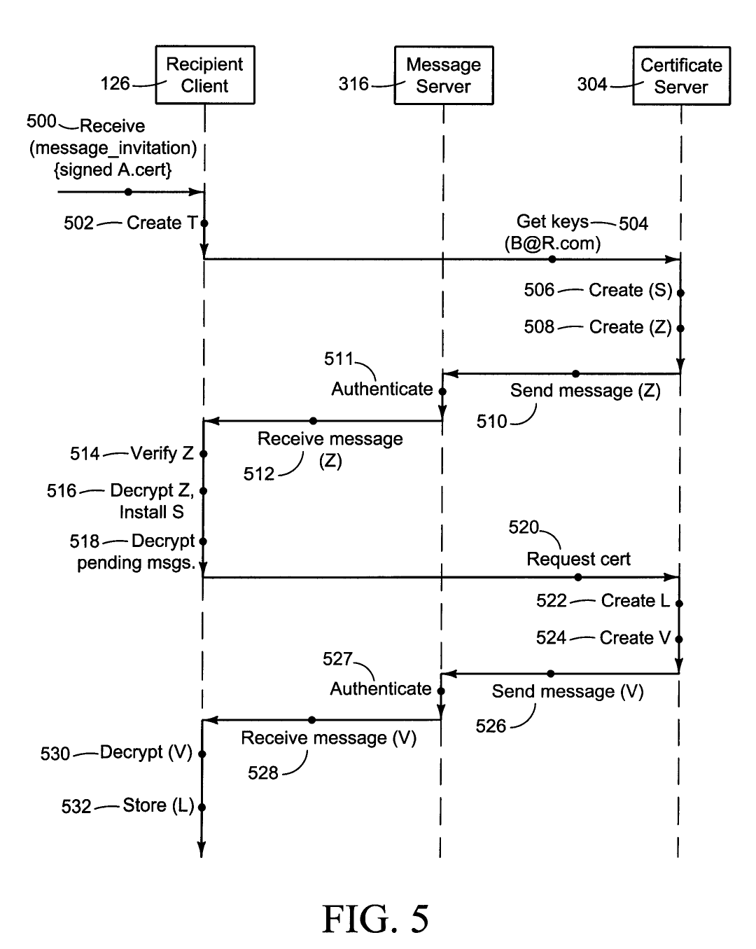

FIG. 5 is a message sequence chart describing a message-only authentication process involving an exchange of messages. For clarity, the process shown in FIG. 5 assumes that the recipient client had already downloaded reader component 310, or has acquired the ability to interact with the PKI in an alternative process. The messages shown in FIG. 5 may be, without limitation, e-mail messages.

In FIG. 5, recipient client 126 receives 500 an activation invitation and message. Recipient client 126 creates 502 a temporary certificate T. The temporary certificate may be self-signed or signed using a local certificate if one is already resident on recipient client 126. The temporary certificate optionally contains information regarding the recipient and the recipient client 126.

Recipient client 126 sends a GetKeys request 504 to certificate server 304. GetKeys request 504 is signed with temporary certificate T and includes the email identity of the recipient, B@R.com. If certificate T is signed by a local certificate, the local certificate may also be sent as a chain of certificate T.

Upon receiving request 504, certificate server 304 creates 506 a public/private key pair and a short term certificate S if they do not already exist for the recipient. Short term certificate S is used with an unverified recipient. Optionally, certificate server 304 may add additional attributes to S, and optionally may digitally sign S.

Certificate server 304 creates 508 a message Z by aggregating certificate S and the recipient's private key, B.pr key, and encrypting the aggregate using temporary certificate T. Certificate server then sends 510 and message containing message Z to recipient client 126 via message server 316. To receive the message, the recipient must authenticate 511 to the message server 316; that is, login or otherwise confirm his identity.

Upon receiving 512 the message containing message Z, recipient client 126 optionally verifies 514 message Z. Verification means that the content of the message meet certain criteria, whether the sender is proper, file format is proper, the message has been properly signed, and so on. Recipient client 126 may then decrypt message Z using temporary certificate T, which is still resident on recipient client 126. After decrypting Z, temporary certificate T may be discarded. Recipient client 126 then installs 516 short term certificate S acquired from message Z. Recipient client 126 may then decrypt 518 any pending messages.

Meanwhile, after installing short term certificate S, recipient client 126 may request 520 a long term certificate L. In some embodiments, certificate S may comply with PKCS10 to improve security. In response, certificate server 304 generates 522 a public/private key pair and a corresponding long term certificate L, then encrypts L using short-term certificate S to create 524 a message V. L may also contain attributes showing the verification status as “message verified.” Certificate server sends 526 a message containing message V through message server 316 to recipient client 126.

Recipient client 126 authenticates 527 to message server 316, then receives 528 the message containing message V, decrypts 530 V to extract long term certificate L, then stores 532 certificate L for later use. In an alternative embodiment, the message containing V may be sent directly to recipient client 126 and bypassing message server 316 because the verification step has been already performed.

The exchange of encrypted message between recipient client 126 and certificate server 304, combined with the authentication of the recipient by message server 316 provides an adequate level of trust for many transactions. However, a “message verified” level of trust may be subverted by an impersonation attack, an attack performed by a third party who has access to the message server login.

The exemplary embodiments described above are amenable to implementation using e-mail and e-mail formats to send messages and using certificates to distribute keys. Skilled artisans will recognize that other formats and communication channels may be used, including, without limitation, proprietary formats.

Payment Authentication

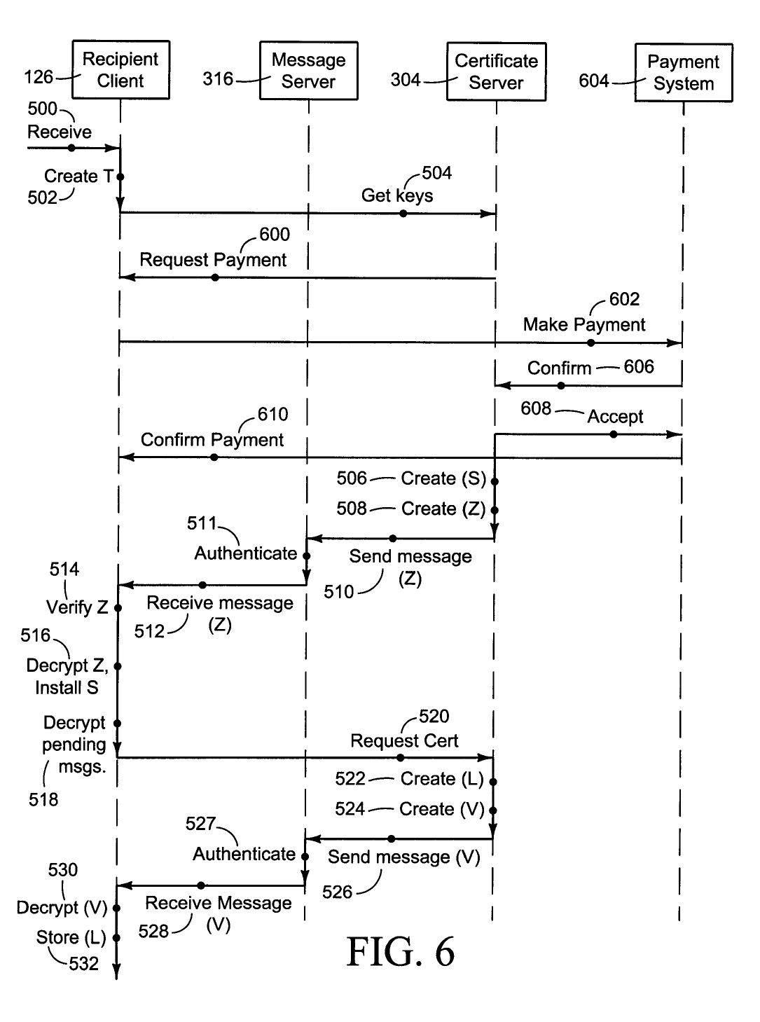

A higher level of trust may be achieved by including a payment step involving a payment system. FIG. 6 describes a PKI that increases trust by adding payment steps to the steps described in FIG. 5.

Referring to FIG. 6, steps 500 through 504 are the same as described above for FIG. 5. Upon receiving GetKeys request 504, certificate server 304 requests 600 payment by the recipient. The request payment message may optionally be encrypted using the short term certificate. The recipient makes 602 a payment to a payment system 604. Payment system 604 may be a transaction system promulgated by credit card companies such as American Express®, Visa®, or MasterCard®, or an online payment system such as PayPal®. The recipient may use recipient client 126 to make the payment if it has features enabling payment, or the recipient may make payment without using recipient client 126.

Payment system confirms 606 payment to certificate server 304. Certificate server 304 may optionally responds 608 with an accept payment message. Payment system 604 may optionally send 610 a confirm payment message to recipient client 126. In some embodiments, the confirm message 606 and the accept message 608 may be encrypted.

Meanwhile, recipient client 126 waits for a message from certificate server 304. Certificate server 304 and recipient client 126 execute steps 506 through 532 as described above for FIG. 5. However, long-term certificate L may include the additional attribute of “payment verified.”

After completion of the steps shown in FIG. 6, the recipient has attained two levels of trust, “message verified” and “payment verified.” Thus, by including a third party payment system in the authentication process, the overall level of trust is greater than message authentication alone. The level of trust may be communicated to users by the attributes of the long-term certificate L. Alternatively, a user may query registry 110 or certificate server 304 for a recipient's trust attributes. Using these attributes, users may evaluate whether to communicate or perform a transaction with a given recipient.

While the embodiment shown in FIG. 6 requires a payment to be made, an equivalent level of trust may be achieved through a null payment, a transaction performed solely for verification purposes. Similarly, a credit check may be performed as a substitute for payment or in addition to payment to add an additional level of trust.

Foreign Certificate Authentication

In some cases, a user may already be registered with a registry and has a certificate already issued to him, but the user may want his identity associated with a foreign certificate, F.

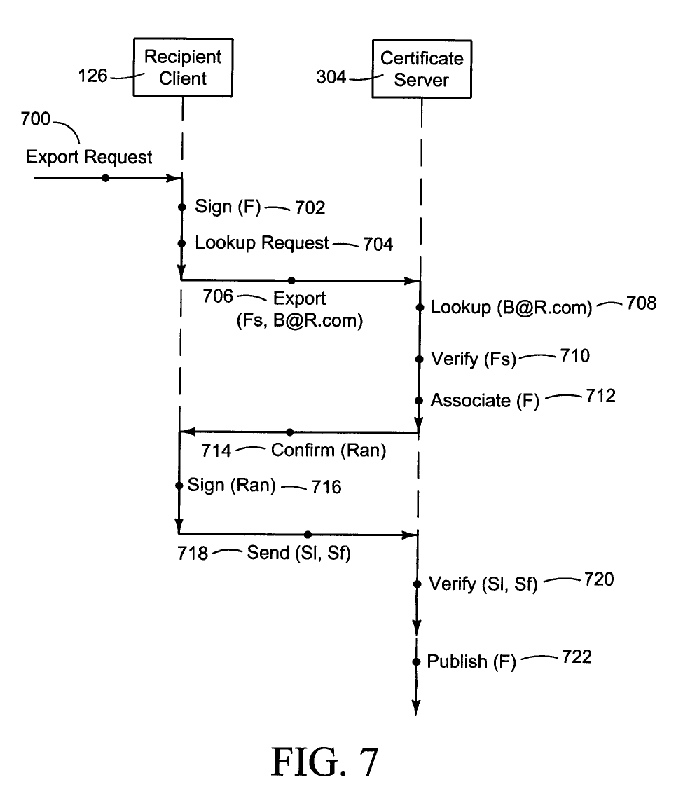

Foreign certificates are those certificates issued by CAs other than certificate server 304. Some CAs require additional authentication steps, such as notarized statements or biometric identification. Some levels of trust may require secure devices to hold private keys. Embodiments of the systems shown in FIG. 5 or FIG. 6 may be enhanced with additional steps to export a foreign certificate residing on recipient client 126 to client server 304, as in the embodiment shown in FIG. 7. Exporting a foreign certificate increases the trust level, because an additional authentication step was required to issue the foreign certificate.

Referring to FIG. 7, a user or external process may initiate 700 a request to export a foreign certificate already issued to the recipient and resident on recipient client 126. Recipient client 126 signs 702 the foreign certificate F with a certificate previously issued to the recipient by certificate server 304, such as a short-term certificate S (see FIG. 6) or a long-term certificate L (see FIG. 6), to create signed certificate Fs. Recipient client 126 exports 706 the signed certificate to certificate server 304. Certificate server 304 looks up 708 the identity of the recipient to confirm that the recipient is registered. The lookup request is preferably based on the message address of the recipient. Certificate server 304 then verifies that the certificate Fs was actually signed by the recipient using the recipient's certificate stored during registration; in other words, certificate server validly decrypts F using the recipient's public key. Certificate server 304 then stores the foreign certificate F and associates 712 it with the recipient. Optionally, certificate server 304 confirms 714 completion of the transaction with recipient client 126.

When foreign certificates are registered for users, the certificate server need not be the root CA for all users; rather, certificate server 304 acts as a certificate broker, responding to lookup requests with either the locally issued certificate, the foreign certificate, or both, depending on parameters provided in the lookup request.

Registering foreign certificates may also allow a user to resolve certificate requests with the foreign CA before resolving with certificate server 304, improving performance by spreading the request load among several servers.

In a related embodiment, certificate server 304 may act purely as a certificate broker, issuing local short term certificates only for the purpose of uploading and registering foreign certificates. Once registered, the foreign certificates may be used for all subsequent encryption and digital signing.

In some embodiments, HTTPS may be used to ensure that server 304 is valid (authenticated) and that the interaction is encrypted. Digital signing with a foreign certificate at the client's side of a challenge issued by the server assures the server that the client has a private key associated with the foreign certificate. In these embodiments, the client proves to the server that the user has the private keys to both the local certificate and the foreign certificate F.

This proof can be made possible by using one of several mechanisms, one of them being simply that the client has to sign a piece of random data supplied by the server using both the certificates.

Referring again to FIG. 7, certificate server 304 generates random data Ran and sends it to recipient client 126 in step 714. Recipient client 126 signs R in step 716 using the private keys of both the local certificate and the foreign certificate F to obtain Sl and Sf, respectively, then sends (step 718) Sl and Sf to certificate server 304.

Certificate server 304 verifies that the signatures are valid and then “publishes” the association of the foreign certificate F to user B@R.com Subsequent lookup of certificate for user B@R.com will return to both local and foreign certificates.

In another embodiment, recipient client 126 may prove that it has private keys to both the local and foreign certificates by establishing establish an SSL or TLS connection with certificate server 304 with client challenges enabled. Certificate server 304 may use SSL or TLS client challenges to cause recipient client 126 to prove that it has the private keys.

Federation

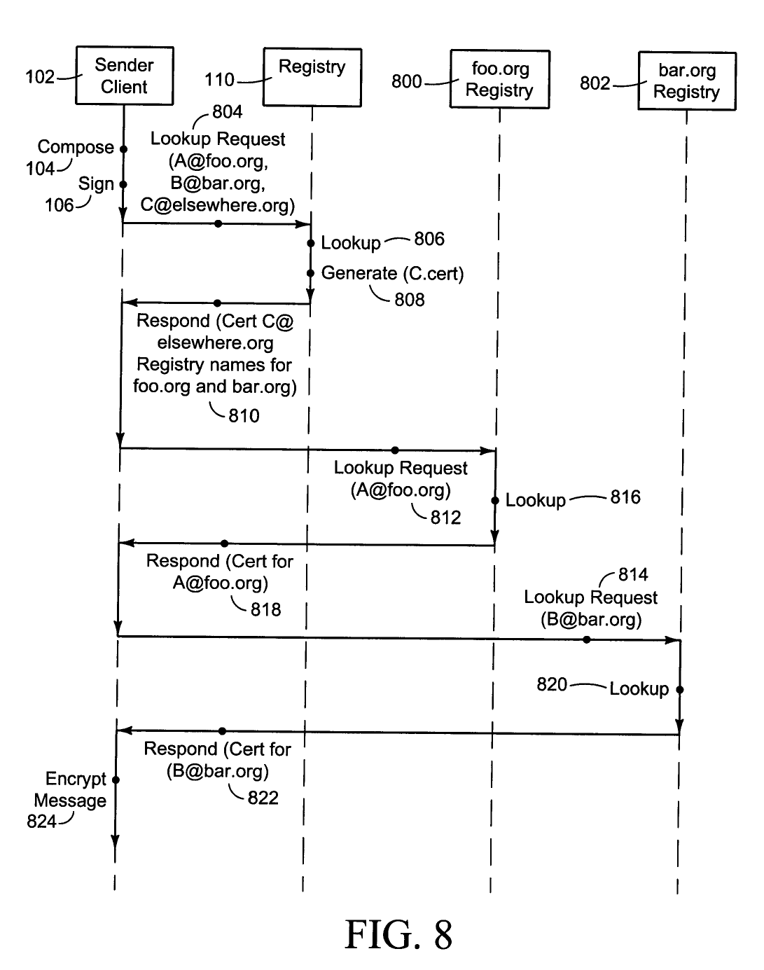

In the embodiment of a basic system shown in FIG. 1, only one registry is used. However, it may be preferable to implement multiple registries in some embodiments. For example, a company may implement a certificate server for its employees, and another certificate server may be implemented by another organization for use by the public. This allows the public and employees to communicate, while spreading the transaction load between multiple servers. This federated architecture allows multiple CAs without registering every user with each CA and exporting the certificates between them. FIG. 8 presents an embodiment of such a federated architecture for registries.

In FIG. 8, an exemplary embodiment having three registries is depicted: a local registry 110, a registry 800 corresponding to the Foo organization, “foo.org,” and a registry 802 corresponding to the Bar organization, “bar.org.” Each of the registries has capabilities similar to that of registry 110 and discussed above for FIG. 1, plus additional capabilities related to federation.

As in FIG. 1, sender client 102 composes 104 a message and signs 106 the message, before sending a lookup request 804 to registry 110. Lookup request 804 requests resolution of three recipients, denoted by “A@foo.org,” “B@bar.org,” and “C@elsewhere.org.” In this example, C@elsewhere.org is an unregistered recipient, A@foo.org is registered on registry 800 but not on registry 110, and B@bar.org is registered on registry 802, but not on registry 110.

In lookup step 806, registry 110 searches for an entry corresponding to the address of each recipient. Because a corresponding entry is not found for C@elsewhere.com, registry 110 generates 808 a public/private key pair and corresponding certificate, C.cert, and registers C@elsewhere.com in the registry.

In this example, lookup request 806 will not find a corresponding entry for A@foo.org or B@bar.org. As part of the lookup step 806, certificate server 304 will resolve the organization identifier and recognize that these recipients, if registered, will reside in other, federated registries. Registry 110 then responds 810 with the new certificate for recipient C, C. cert, and identifiers for the two other registries, foo.org and bar.org. Registry 110 selects which identifiers to send based on attributes in lookup request 804; in this example, the domain names of the recipients.

Sender client 102, upon receiving response 810, sends a lookup request 812 for recipient A@foo.org to registry 800, and sends a lookup request 814 for recipient B@bar.org to registry 802. Registry 800 performs a lookup 816, then responds 818 with the certificate for A, and registry 802 performs a lookup 816, then responds 822 with the certificate for B. After receiving all the recipient's certificates, sender client 102 encrypts 820 the message composed in step 104.

Registry

In many embodiments, the functions of registry 102 (FIGS. 1 and 8) and certificate server 304 (FIGS. 3 and 5-7) may be combined. Whether or not combined, a register associating users with certificates may take the form of a table of associations; an illustrative example is shown in Table 1.

TABLE 1

| | | | Identity | | Can | Can |
|---|---|---|---|---|---|---|
| Identity | Trust level | Issuer | Strength | Certificate | Encrypt | Sign |
| A@x.com | unverified | Local | Low | Cert.short_term.A | Y | Y |
| B@y.com | unverified + payer_verified | Local | Low | Cert.short_term.B | Y | Y |
| C@z.com | message_verified | Local | Low | Cert.long_term.C | Y | Y |
| D@z.com | message_verified + foreign_verified | Local + z.com | Medium | Cert.long_term.D | Y | Y |
| | | | | Cert.foreign.D | | |

In the embodiment shown in Table 1, “Identity” corresponds to the identity of the recipient. While e-mail addresses are shown, identity may be based on another attribute, such as an employee number or social security number. “Trust level” shows example entries corresponding to unverified, message verified, payer verified, and foreign verified trust levels. “Issuer” corresponds to the issuer of the certificates. In the examples shown, “local” means the registry containing the table issued the certificate. “Identity Strength” corresponds to the strength of identification used to achieve a trust level. For example, a trust level may be “foreign_verified” upon receipt of a foreign certificate using biometric identification, resulting in a high strength of identity. However, the identity strength may be reduced if, for example, the foreign certificate were to expire. “Certificate” corresponds to the actual certificates stored in the registry and corresponding to the user. “Can encrypt” and “Can sign” correspond to the ability of a particular user to encrypt messages and sign messages, respectively. Depending on the system, this may mean the registration of appropriate public keys and private keys, or the presence of encryption certificates and signing certificates.

In alternative embodiments, additional fields may be added, or the fields described may be eliminated. Skilled artisans will recognize that the table of associations need not literally contain the field labels and entries shown, and that other entries and labels corresponding to the functions and purposes described may be used. For example, while “low,” “medium,” and “high” are shown for identity strength in the exemplary embodiment, the strength may be described using integers. Columns and rows may be interchanged, or the table may be implemented as a database, including, without limitation, an object, relational, or flat database.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. For example, while embodiments described above illustrate message communications, of the present invention were developed for e, the invention is not limited to use with @ and may be used with other @. While the invention is not limited to use with @, it is expected that various embodiments of the invention will be particularly useful in such devices. Hence, the foregoing description should not be construed to limit the scope of the invention, which is defined in the following claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A method for sending encrypted communications, comprising the steps of:
generating a key pair comprising a public key and a private key, the key pair corresponding to a recipient;
sending the public key to a sender;
encrypting a message with the public key; and
sending the key pair to the recipient, wherein the key pair is sent to the recipient after the step of encrypting the message with the public key;
whereby the encrypted message may be sent to the recipient before the recipient has received the private key.

2. The method of claim 1, further comprising the step of sending an invitation message to the recipient.

3. The method of claim 1, further comprising the step of downloading a reader software component to a recipient client, wherein the reader software component is capable of receiving the key pair and decrypting the encrypted message for reading by the recipient.

4. The method of claim 1, wherein the message is an e-mail message.

5. The method of claim 1, wherein the step of sending the public key to the sender comprises including the public key in a certificate.

6. A method for authenticating a user for encrypted communications, comprising the steps of:
generating a temporary key pair comprising a temporary public key and a temporary private key;
sending the temporary public key to a server;
generating a short term key pair comprising a short term public key and a short term private key, the short term key pair corresponding to a recipient;
encrypting the short term key pair with the temporary public key;
sending the encrypted short term key pair to a message server;
authenticating the identity of the recipient to the message server;
receiving the encrypted short term key pair;
decrypting the short term key pair with the temporary private key;
sending a request for a long term key pair, the request encrypted with the short term private key;
upon receiving the request, generating a long term key pair comprising a long term public key and a long term private key, the long term key pair corresponding to the recipient; and
sending the long term key pair to the recipient.

7. The method of claim 6, wherein the step of sending the long term key pair to the recipient comprises the steps of:
encrypting the long term key pair with the short term public key;
sending the encrypted long term key pair to a message server;
authenticating the identity of the recipient to the message server;
receiving the encrypted long term key pair; and
decrypting the short term key pair with the temporary private key.

8. The method of claim 6, wherein the step of sending the encrypted short term key pair to a message server comprises including the encrypted short term key pair in an e-mail message.

9. The method of claim 6, wherein the step of sending the public key to the sender comprises including the public key in a certificate.

10. The method of claim 6, further comprising the steps of:
making a payment to a payment system; and
confirming payment completion to the server;
wherein the step of confirming payment completion occurs prior to the step of generating a short term key pair.

11. The method of claim 6, further comprising the steps of:
encrypting a foreign key pair comprising a foreign public key and a foreign private key;
sending the encrypted foreign key pair to the server;
decrypting the foreign key pair; and
associating the foreign key pair with the recipient.

12. The method of claim 6, further comprising the step of registering a trust level corresponding to the recipient.

13. The method of claim 12, wherein the trust level is “unverified,” “message verified,” “foreign verified,” or “payer verified.”

14. The method of claim 12, wherein the step of registering a trust level comprises making an entry into a database.

15. The method of claim 6, further comprising the step of registering an identity strength corresponding to the recipient.

16. The method of claim 15, wherein the identity strength is “unverified,” “message verified,” “foreign verified,” or “payer verified.”

17. The method of claim 15, wherein the step of registering the identity strength comprises making an entry into a database.

18. A method for sending encrypted communications, comprising the steps of:
sending a lookup request corresponding to a first recipient from a sender client to a first registry;
selecting an identifier of a second registry;
responding to the sender client with the identifier of the second registry;
sending a lookup request corresponding to the first recipient from the sender client to the second registry;
sending a first public key corresponding to the first recipient to the sender client; and
encrypting a message with the public key.

19. The method of claim 18, further comprising the steps of:
generating a second key pair comprising a second public key and a second private key, the second key pair corresponding to a second recipient;
sending the second public key to the sender client;
encrypting the message with the second public key; and
sending the second key pair to the second recipient, wherein the second key pair is sent to the second recipient after the step of encrypting the message with the second public key;
whereby the encrypted message may be sent to the second recipient before the recipient has received the second private key.

20. A system for secure communications, comprising:
a recipient client;
a sender client capable of composing an message, sending a request for a first public key corresponding to a recipient, encrypting the message with the first public key, and sending the encrypted message to the recipient client; and
a registry capable of receiving the request for the public key corresponding to the recipient, generating a first key pair comprising the first public key and a first private key, sending the first public key to the sender client, and sending the first private key to the recipient client;
wherein the recipient client is capable of receiving the key pair after receiving the message from the sender client.

21. The system of claim 20, wherein the registry is further capable of generating a second private key pair comprising a second public key and a second private key, and sending the second private key pair to the recipient client after receiving a proof message containing proof of authentication.

22. The system of claim 21, wherein the proof of authentication is based upon authentication by an e-mail server or authentication by a payment system.

23. The system of claim 20, wherein the registry is further capable of transmitting a reader software component to the recipient client, wherein the reader software component is capable of receiving the key pair and decrypting the encrypted message.

24. The system of claim 20, further comprising a table of associations containing a trust level.

25. The system of claim 24, wherein the trust level is “unverified,” “message verified,” “foreign verified,” or “payer verified.”

26. The system of claim 24, wherein the table of associations is embodied in a database.

27. A set of computer-readable storage media containing a set of instructions for one or more computers, the set of instructions comprising:
means for generating a key pair comprising a public key and a private key, the key pair corresponding to a recipient;
means for sending the public key to a sender;
means for encrypting a message with the public key; and
means for sending the key pair to the recipient, wherein the key pair is sent to the recipient after the step of encrypting the message with the public key;
whereby the encrypted message may be sent to the recipient before the recipient has received the private key.

28. The system of claim 27, further comprising:
means for generating a second private key pair comprising a second public key and a second private key; and
means for sending the second private key pair to the recipient client after receiving a proof message containing proof of authentication.

29. The system of claim 27, further comprising means for registering a recipient.

30. The system of claim 27, further comprising means for registering a recipient.
